(19) United States
(12) Patent Application Publication
(10) Pub. No.: US 2014/0052508 A1
(43) Pub. Date: Feb. 20, 2014

(54) ROGUE SERVICE ADVERTISEMENT DETECTION

(71) Applicants: Santosh PANDEY, Santa Clara, CA (US); Brian Donald Hart, Sunnyvale, CA (US); Andrew Myles, Turramurra (AU)

(72) Inventors: Santosh PANDEY, Santa Clara, CA (US); Brian Donald Hart, Sunnyvale, CA (US); Andrew Myles, Turramurra (AU)

(21) Appl. No.: 13/585,226

(22) Filed: Aug. 14, 2012

(51) Int. Cl. G06Q 30/02

(52) U.S. Cl. 705/14.4

(57) ABSTRACT

In an example embodiment, unauthorized wireless services and advertisements can be detected by access points via active or passive scanning. Unauthorized, or rogue, service advertisements are reported to the venue owner along with contextual information for further mitigation.

### TECHNICAL FIELD

The present disclosure relates generally to detecting rogue service advertisements.

### BACKGROUND

The convenience of mobile devices, including features such as compact size, rich user interface, always-on networking, multiple network interface capabilities and availability of content enable users to learn about the world around them. Wireless local service advertisement is a way to localize and enhance the user experience. For example, the Institute of Electrical and Electronics Engineers (IEEE) 802.11u standard (“.11u”) provides a Generic Advertisement Service (GAS) protocol to allow users to discover and/or request information from a wireless network. Protocols such as MSAP (Mobility Services Advertisement Protocol) available from Cisco Systems, Inc., 170 West Tasman Drive, San Jose, Calif. 95134-1706 leverage the .11u protocol to push service advertisements to a wireless client. Service advertisements are venue based and because guests usually do not have authentication credentials, and for the guest's convenience, service advertisements are provided without the need for a guest to authenticate (e.g. log in) to the wireless network. This can allow a rogue device to advertise unauthorized services and/or disrupt the advertised services provided by a venue.

### BRIEF DESCRIPTION OF THE DRAWINGS

The accompanying drawings incorporated herein and forming a part of the specification illustrate the example embodiments.

FIG. 1 is a diagram illustrating an example of a network employing a rogue service detection engine.

FIG. 2 is a block diagram illustrating an example of an apparatus for implementing a rogue service detection engine.

FIG. 3 is a block diagram of a computer system upon which an example embodiment can be implemented.

FIG. 4 is a signal diagram for detecting a rogue service advertisement.

FIG. 5 is a block diagram of a methodology for detecting a rogue service advertisement.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus comprising an interface and a rogue service detection engine coupled with the interface. The rogue service detection engine is operable to receive a signal from a device on a network via the interface, the signal comprising data representative of a device sending an advertisement for a service advertisement protocol. The rogue service detection engine is operable to send, via the interface, an instruction to the device on the network to request additional data from the device sending the advertisement. The rogue service detection engine is operable to receive, via the interface, data representative of a response to the request for additional data from the device on the network. The rogue service detection engine is operable to determine whether the device sending the advertisement for the service advertisement protocol is a rogue device.

In accordance with an example embodiment, there is disclosed herein logic encoded in a non-transitory tangible computer readable medium for execution by a processor. The logic, when executed, is operable to receive a signal comprising data representative of a device sending an advertisement for a service advertisement protocol. The logic is further operable to send a request for additional data from the device sending the advertisement for the service advertisement protocol. The logic is operable to receive data representative of a response to the request for additional data. The logic is further operable to determine whether the device sending the advertisement for the service advertisement protocol is a rogue device.

In accordance with an example embodiment, there is disclosed herein, a method that comprises receiving a signal comprising data representative of a device sending an advertisement for a service advertisement protocol. A request is sent for additional data from the device sending the advertisement for the service advertisement protocol. Data representative of a response to the request for additional data is received. A processor determines whether the device sending the advertisement for the service advertisement protocol is a rogue device based on the response to the request. A location of the device sending the advertisement is determined and an alarm is sent responsive to determining the device sending the advertisement is a rogue device. The alarm comprises data representative of the location of the device sending the advertisement.

### Description of Example Embodiments

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, as part of normal scanning or via an additional scan, enterprise access points (APs) scan to detect unauthorized services/advertisements, record their relevant attributes, optionally classify the rogue services into levels of risk, and report the results to the venue owner.

There are many different techniques that can be employed for detecting rogue service advertisements. For example, for a Rogue MSAP service, APs (e.g. rogue APs) that advertise MSAP capability in their beacons are identified. The enterprise wireless local area network (WLAN) infrastructure selects a neighboring enterprise AP, either on the rogue service advertiser's channel (or changes the AP's channel to the rogue service advertiser's channel), that sends an MSAP request to the rogue service advertiser in order to obtain the list of MSAP services advertised by the rogue service advertiser. Another technique to identify rogue APs is to monitor beacons and/or probe responses from APs outside the enterprise WLAN that advertise themselves as GAS enabled. These APs can be flagged. In particular embodiments, a GAS request may be sent out to the GAS-enabled AP to identify additional details of the rogue services advertised by the GAS-enabled AP. As one skilled in the art can readily appreciate, the AP can detect the rogue services via passive or active monitoring.

In an example embodiment, if an advertised service includes raw text, the text can be compared against a list of keywords for competing or offensive (or otherwise undesirable) services. In particular embodiments, if the advertised service includes artwork, such as a logo, Optical Character Recognition (OCR) software can be applied to obtain text that can be compared against a list of keywords for competing or offensive (or otherwise undesirable) services. In another example embodiment, if raw text or OCR'ed text suggests one thing but the service advertisement contains a Uniform Resource Locator (URL) pointing to something else (e.g., “Nike” icon but “Adidas” URL), the service can be flagged. In an example embodiment, if the advertised service includes a URL, the domain name can be compared against a watch list of competitor (or otherwise undesirable) sites. In addition, the domain name or URL can be compared against lists of unsafe sites (that can be maintained by third parties and accessible to the WLAN infrastructure via a client/server architecture). In particular embodiments, if the advertisement is signed, such as by a certificate authority, the identity of the certificate authority or other party signing the advertisement may be obtained.

In an example embodiment, Mechanical Turks (e.g., a service provider that uses people to perform tasks better handled by humans than computers) can be deployed in addition to, or as an alternative to, the automated processing described above. For example, a database of white-list and black-list service advertisements can be maintained using filtered Mechanical Turk classifications, with new service advertisements not already on a white list or a black list directed the Mechanical Turks. Well-behaved service advertisers can even pre-submit their ads for inclusion into the white-list/black-list database.

In an example embodiment, in addition to determining the attributes of a service advertisement such as type of service and owner of the service etc., contextual (e.g., location-timestamp) information of the AP advertising a rogue service can also be obtained by a mobility services engine (MSE). This allows the venue owner to understand the rogue service advertisements and can help the owner take mitigating action. For example, APs advertising rogue services can be located and disabled.

Although the description herein refers to an AP advertising rogue services, the example embodiments described herein can be easily extended to any rogue station broadcasting the services and/or advertisements. For example, a mobile smart phone can act as a rogue AP. As those skilled in the art can readily appreciate, the example principles described herein, can also be used on wired network to detect any rogue service. Although the example embodiments described herein assume infrastructure-side processing, those skilled in the art can readily appreciate that the principles described herein (e.g., offensive/dangerous site filtering) can be implemented by client-side processing, which in particular embodiments can be aided by publically available servers.

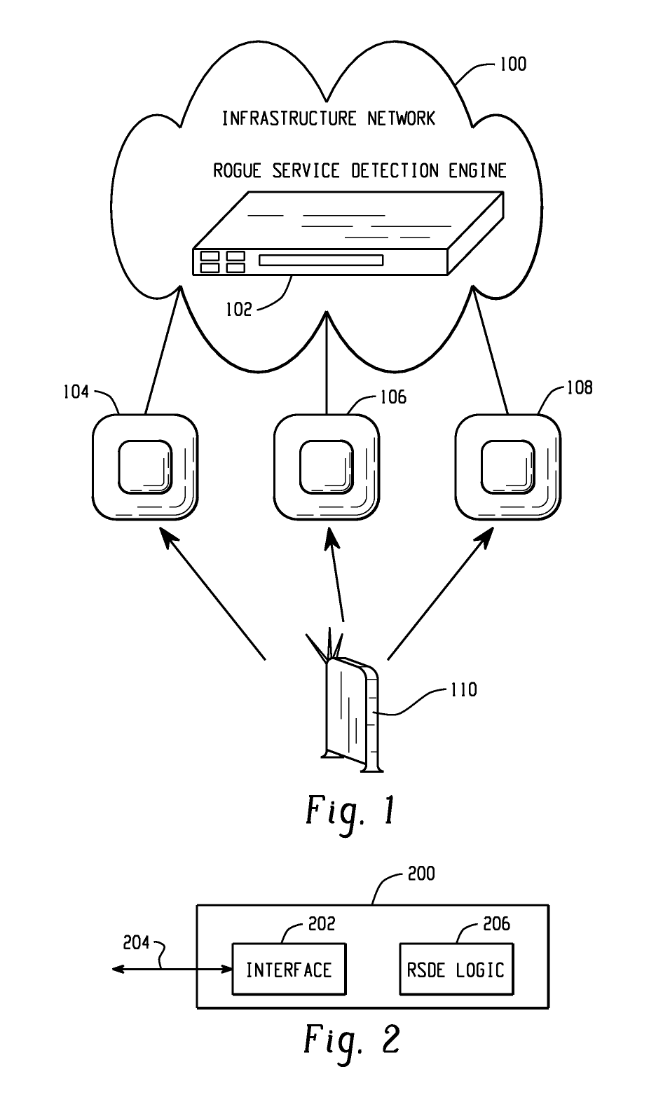

FIG. 1 is a diagram illustrating an example of a network 100 employing a rogue service detection engine (RSDE) 102. As will be described in more detail herein, see e.g., FIG. 2, RSDE 102 suitably comprises logic for performing the functionality described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In the illustrated example, RSDE 102 is coupled with three APs 104, 106, 108. As those skilled in the art can readily appreciate, three APs 104, 106, 108 were selected merely for ease of illustration as the network 100 may be coupled with any physically realizable number of APs. A rouge service advertising device 110 broadcasts a signal (a wireless signal in this example, but the principles described herein are also applicable to wired networks). The signal broadcast by the rogue service advertising device 110 comprises data indicating that the rouge service advertising device 110 is capable of supporting a predefined service advertisement protocol. The service advertisement protocol may be any suitable service advertising protocol such as MSAP and/or GAS.

The signal sent by the rogue service advertising device 110 may be received by any of the APs 104, 106, 108, or any combination of the APs 104, 106, 108. An AP receiving the signal sends a message to the RSDE 102 with data representative of the signal. For example, the AP may encapsulate the signal and forward the signal to the RSDE 102.

The RSDE 102 upon receiving the data representative of the signal from the rogue service advertising device 110 from one or more of APs 104, 106, 108 sends an instruction, for example a command, to one or more of APs 104, 106, 108 to request additional data from the rogue service advertising device 110. For example, the instruction may instruct the AP to send a packet requesting a list of available services and the provider of those services.

One or more of APs 104, 106, 108 sends a signal to the rogue service advertising device 110 requesting the additional data about the available services. For example, the AP or APs may send a packet requesting a list of available services and the provider of those services. Upon receiving a response to the request for additional data about the available services, the AP or APs receiving a response forward data representative of the response to the RSDE 102.

The RSDE 102 is operable to determine whether the rogue service advertising device 110 is a rogue device. In an example embodiment, the RSDE 102 determines the location of the rogue service advertising device 110 in response to determining that the rogue service advertising device 110 is a rogue device. For example, the RSDE 102 may determine the location of the rogue service advertising device 110 based on received signal strength indication (RSSI) data, angle of arrival (AOA) data, or any other suitable technique. In particular embodiments, the network 100 may be coupled with a mobile services engine, or “MSE”, (not shown) and obtain location data from the MSE. The RSDE 102 transmits an alarm indicating a rogue service advertisement has been detected, the alarm comprising data representative of the location of the rogue service advertising device 110.

In an example embodiment, the data representative of a response to the request for additional data comprises textual data. The RSDE 102 is operable to search the textual data for predefined keywords. The RSDE 102 can determine that the rogue service advertising device 110 is a rogue device responsive to finding a one of the predefined keywords in the textual data in the response.

In an example embodiment, the data representative of a response comprises graphical data. For example, the graphical data may be a logo or icon. The RSDE 102 is operable to perform an optical character recognition (OCR) scan of the graphical data to obtain textual data. The RSDE 102 searches the textual data for predefined keywords and can determine that the rogue service advertising device 110 is a rogue device responsive to finding any one of the predefined keywords in the textual data.

In an example embodiment, the response comprises a uniform resource locator (URL) and a source of the service advertisement. The RSDE 102 determines whether the URL is the appropriate URL for the service provider. The RSDE 102 is operable to determine that rogue service advertising device 110 is a rogue device responsive to determining the URL does not match the source of the service advertisement.

In an example embodiment, the response comprises a URL. The RSDE 102 searches a list of undesirable sites for the URL. The RSDE 102 can determine that the rogue service advertising device 110 is a rogue device if the RSDE 102 finds a match for the URL in the list of undesirable sites. The list of undesirable sites may include competitor sites, or other known undesirable sites.

In an example embodiment, the response comprises a domain name. The RSDE 102 is operable to search for the domain name in a list of unsafe sites. The RSDE 102 can determine that the rogue service advertising device 110 is a rogue device if the RSDE 102 finds a match for the domain name in the list of unsafe sites.

In an example embodiment, the RSDE 102 is operable to search a database comprising approved service advertisements for the service advertisement. If the RSDE 102 does not find the service advertisement in the list of approved service advertisements, the RSDE 102 searches a database of unapproved service advertisements for the service advertisement. If the RSDE 102 finds a match for the service advertisement in the list of unapproved service advertisements, the RSDE 102 determines that the rogue service advertising device 102 is a rogue device. However, if the RSDE 102 does not find the service advertisement in either the approved service advertisement database, or the unapproved service advertisement database, the RSDE 102 is operable to send a message to a predefined destination. For example, the RSDE 102 may send an email to a predefined email address and/or a short message service (SMS) message to a predefined destination.

In an example embodiment, the RSDE 102 is operable to obtain a media access control (MAC) address associated with the rogue service advertisement device 110. The RSDE 102 is operable to search a database of approved MAC addresses for the MAC address associated with the device sending the advertisement for the service advertisement protocol. If the RSDE 102 cannot find the MAC address, the RSDE 102 determines that the rogue service advertising device 110 is a rogue device.

In an example embodiment, RSDE 102 is operable to determine a location of the device sending the advertisement for the service advertisement protocol. The RSDE 102 also obtains a MAC address associated with the rogue service advertisement device 110. The RSDE 102 is operable to search a database of approved MAC addresses for the MAC address associated with the rogue service advertising device 110. The RSDE 102 determines whether the location of the rogue service advertising device 110 matches a location for the MAC address in the database of approved MAC addresses. The RSDE 102 can determine that the rogue service advertising device 110 is a rogue device in response to determining that the location of the rogue service advertising device does not match the location for the device with the corresponding MAC address in the database of approved MAC addresses.

In an example embodiment, the response is signed. The RSDE 102 can determine who signed the response. If the RSDE 102 determines that the rogue service advertisement device 110 is a rogue device, the alarm may comprise data representative of who signed the response (e.g., the name of the certificate authority “CA”).

In an example embodiment, the RSDE 102 may instruct the APs 104, 106, 108 to provide an alert indicating that rogue service advertising device 110 is a rogue device. For example, the APs 104, 106, 108 may provide data representative of rogue devices in beacon and/or probe response frames.

Although the preceding examples illustrate RSDE 102 as a separate device disposed on infrastructure network 100, those skilled in the art can readily appreciate that RSDE 102 may be located anywhere in the network, either as a separate device or integrated with another device. For example, RSDE 102 may be part of a switch (not shown) coupled with APs 104, 106, 108, or may be implemented within APs 104, 106, 108.

FIG. 2 is a block diagram illustrating an example of an apparatus 200 for implementing a rogue service detection engine, such as, for example, the rogue service detection engine 102 described in FIG. 1. The apparatus 100 comprises an interface 202 for communicating with external devices. The interface is coupled with a bi-directional link 204 that is coupled with the external devices. Bi-directional link 204 may be a wired link, a wireless link, or may suitably comprise wired and/or wireless links. RSDE logic 206 is operable to send and receive data with external devices, such as infrastructure APs, that are coupled with the bi-directional link 204.

In an example embodiment, the RSDE logic 206 is operable to receive a signal from a device on a network via the interface 202. The signal comprises data representative of a device sending an advertisement for a predefined service advertisement protocol. The RSDE logic 206 is operable to send, via the interface 202, an instruction to the device on the network to request additional data from the device sending the advertisement. The RSDE logic 206 is operable to receive, via the interface 202, data representative of a response to the request for additional data from the device on the network. The RSDE logic 206 is operable to determine whether the device sending the advertisement for the predefined service advertisement protocol is a rogue device.

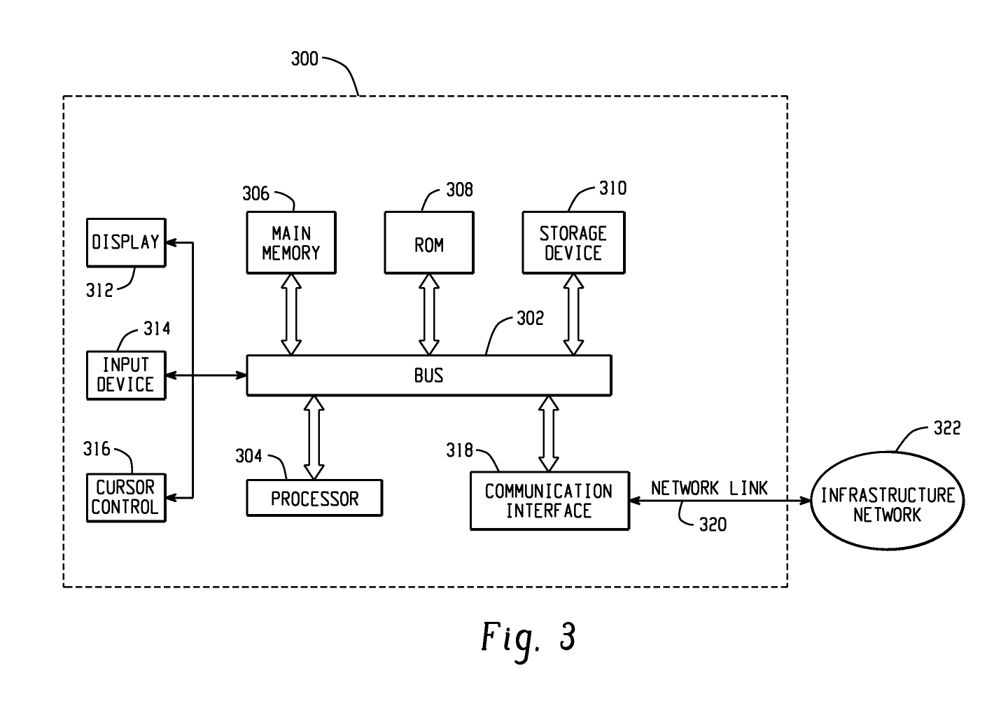

In an example embodiment, the RSDE logic 206 determines the location of the device sending the advertisement for the predefined service advertisement protocol responsive to determining that the device sending the advertisement for the predefined service advertisement protocol is a rogue device. The RSDE logic 206 is further operable to transmit an alarm indicating a rogue service advertisement has been detected, the alarm comprising the location of the device sending the advertisement for the predefined service advertisement protocol. The alarm may be sent by any suitable means. For example, an audio alert may be generated. A video alert placed on a display (not shown, see, e.g., FIG. 3). In an example embodiment, a message may be transmitted to a predefined destination. For example, an email and/or SMS text may be sent to a network administrator or other designated person. The predefined keywords may suitably comprise competitor web sites, rogue web sites, and/or undesirable web sites. In an example embodiment, the data representative of a response to the request for additional data comprises textual data. The RSDE logic 206 is operable to search the textual data for predefined keywords. If the RSDE logic 206 finds one of the predefined keywords in the response, the RSDE logic 206 is operable to determine that the device sending the advertisement for the predefined service advertisement protocol is a rogue device. The RSDE logic 206 may generate an alarm accordingly.

In an example embodiment, the data representative of a response comprises graphical data. For example, the graphical data may be a logo and/or icon for the service provider. In other embodiments, the graphical data may include a visual cue for the service being advertised. The RSDE logic 206 performs an optical character recognition (OCR) scan of the graphical data to obtain textual data. The RSDE logic 206 searches the textual data for predefined keywords. If the RSDE logic 206 finds a predefined keyword, the RSDE logic 206 determines that the device sending the advertisement for the predefined service advertisement protocol is a rogue device and generates an alarm accordingly.

In an example embodiment, the response comprises a uniform resource locator (URL) and a source of the predefined service advertisement. The RSDE logic 206 determines whether the URL matches the alleged source of the service. If the URL does not match the URL for the alleged source, the RSDE logic 206 is operable to determine the device sending the advertisement for the predefined service advertisement protocol is a rogue device and generate an alarm accordingly.

In an example embodiment, the response comprises a uniform resource locator (URL). The RSDE logic 206 searches a list of undesirable sites for the URL. If the URL is found in the list of undesirable sites, the RSDE logic 206 is operable to determine the device sending the advertisement for the predefined service advertisement protocol is a rogue device and generates an alarm accordingly. In particular embodiments, the list of undesirable sites includes data representative of competitor sites.

In an example embodiment, the response comprises a domain name. The RSDE logic 206 searches for the domain name in a list of unsafe sites and/or undesirable sites. If the domain name is found in the list of unsafe and/or undesirable sites, the RSDE logic 206 is operable to determine that the device sending the advertisement for the predefined service advertisement protocol is a rogue device and generates an alarm accordingly.

In an example embodiment, RSDE logic 206 is operable to search a database comprising approved service advertisements for the service advertisement. If the RSDE logic 206 finds the service advertisement in the database of approved service advertisements, no further action needs to be taken.

In an example embodiment, the RSDE logic 206 is operable to search a database of unapproved service advertisements for the predefined service advertisement. This search may be performed independently or as a result of not finding the service advertisement in the database of approved service advertisements. If the RSDE logic 206 finds the service advertisement in the database of unapproved service advertisements, the RSDE logic 206 determines that the device sending the advertisement for the predefined service advertisement protocol is a rogue device and generates an alarm accordingly.

In an example embodiment, if the RSDE logic 206 cannot find the service advertisement in the approved database or the unapproved database, the RSDE logic 206 sends a message to a predefined destination. The predefined destination may be any suitable output device such as an audio device, visual device and/or audiovisual device, or may be an email address and/or SMS destination. In particular embodiments, the RSDE logic 206 may receive a response to the message indicating whether the service advertisement is a rogue service advertisement, and if the service advertisement is a rogue service advertisement, the RSDE logic 206 may generate an alarm accordingly.

In an example embodiment, the RSDE logic 206 is operable to obtain a media access control (MAC) address associated with the device sending the advertisement for the predefined service advertisement protocol. The RSDE logic searches a database of approved MAC addresses for the MAC address associated with the device sending the advertisement for the predefined service advertisement protocol. If the MAC address is not found, the RSDE logic 206 determines that the device sending the advertisement for the predefined service advertisement protocol is a rogue device and may generate an alarm accordingly.

In an example embodiment, the RSDE logic 206 obtains a MAC address associated with the device sending the advertisement for the predefined service advertisement protocol, and also a location for the device sending the advertisement for the predefined service advertisement protocol. The RSDE logic 206 determines whether the MAC address matches the location for the device sending the advertisement for the predefined service advertisement protocol. For example, RSDE logic 206 may search a database of approved MAC addresses for the MAC address associated with the device sending the advertisement for the predefined service advertisement protocol that also includes location data. The RSDE logic 206 is operable to generate an alarm responsive to determining the location of the device sending the advertisement for the predefined service advertisement protocol is not the correct location for the MAC address in the database of approved MAC addresses.

In an example embodiment, the RSDE logic 206 may determine whether the response is signed. If the certificate authority (CA) or other entity signing the response does not match the CA for the venue, the RSDE logic 206 may determine that the device sending the response is a rogue device, and may generate an alarm accordingly. The alarm may further include data representative of who signed the response. In particular embodiments, if the device sending the response is determined to be a rogue device for other reasons (for example, for any of the reasons described herein, such as the response containing a predefined keyword, etc.), the RSDE logic 206 can include data representative of who signed the response in the alarm.

FIG. 3 is a block diagram of a computer system 300 upon which an example embodiment can be implemented. Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk, optical disk, and/or flash storage, is provided and coupled to bus 302 for storing information and instructions.

Computer system 300 may be coupled via bus 302 to a display 312, such as a cathode ray tube (CRT) or liquid crystal display (LCD), for displaying information to a computer user. An input device 314, such as a keyboard including alphanumeric and other keys is coupled to bus 302 for communicating information and command selections to processor 304. Another type of user input device is cursor control 316, such as a mouse, a trackball, cursor direction keys, and/or a touchscreen for communicating direction information and command selections to processor 304 and for controlling cursor movement on display 312. This input device typically has two degrees of freedom in two axes, a first axis (e.g., x) and a second axis (e.g., y) that allow the device to specify positions in a plane.

An aspect of the example embodiment is related to the use of computer system 300 for detecting rogue service advertisements. According to an example embodiment, detecting rogue service advertisements is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, including but not limited to non-volatile media, and volatile media. Non-volatile media include, for example, optical or magnetic disks, such as storage device 310. Volatile media include dynamic memory, such as main memory 306. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Various forms of computer-readable media may be involved in carrying one or more sequences of one or more instructions to processor 304 for execution. For example, the instructions may initially be borne on a magnetic disk of a remote computer. The remote computer can load the instructions into its dynamic memory and send the instructions over a telephone line using a modem. A modem local to computer system 300 can receive the data on the telephone line and use an infrared transmitter to convert the data to an infrared signal. An infrared detector coupled to bus 302 can receive the data carried in the infrared signal and place the data on bus 302. Bus 302 carries the data to main memory 306 from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling computer system 300 to a network link 320 that is connected to a network, such as an infrastructure network 322. For example, communication interface 318 may be a local area network (LAN) card to provide a data communication connection to a compatible LAN. As another example, communication interface 318 may be an integrated services digital network (ISDN) card or a modem to provide a data communication connection to a corresponding type of telephone line. Wireless links may also be implemented. In any such implementation, communication interface 318 sends and receives electrical, electromagnetic, or optical signals that carry digital data streams representing various types of information.

In an example embodiment, computer system 300 receives data representative of a device advertising capabilities associated with a service advertisement protocol from a device (not shown) disposed on infrastructure network 322. Computer system 300 may send an instruction to the device disposed on infrastructure network to request additional data for the service advertisement, and receive a response with additional data. Computer system 300 can determine whether the device advertising capabilities associated with the service protocol based on the additional data using any of the techniques described herein. Computer system 300 may generate an alarm which may be output on display 312 or sent in a message to a predefined destination via communication interface 318.

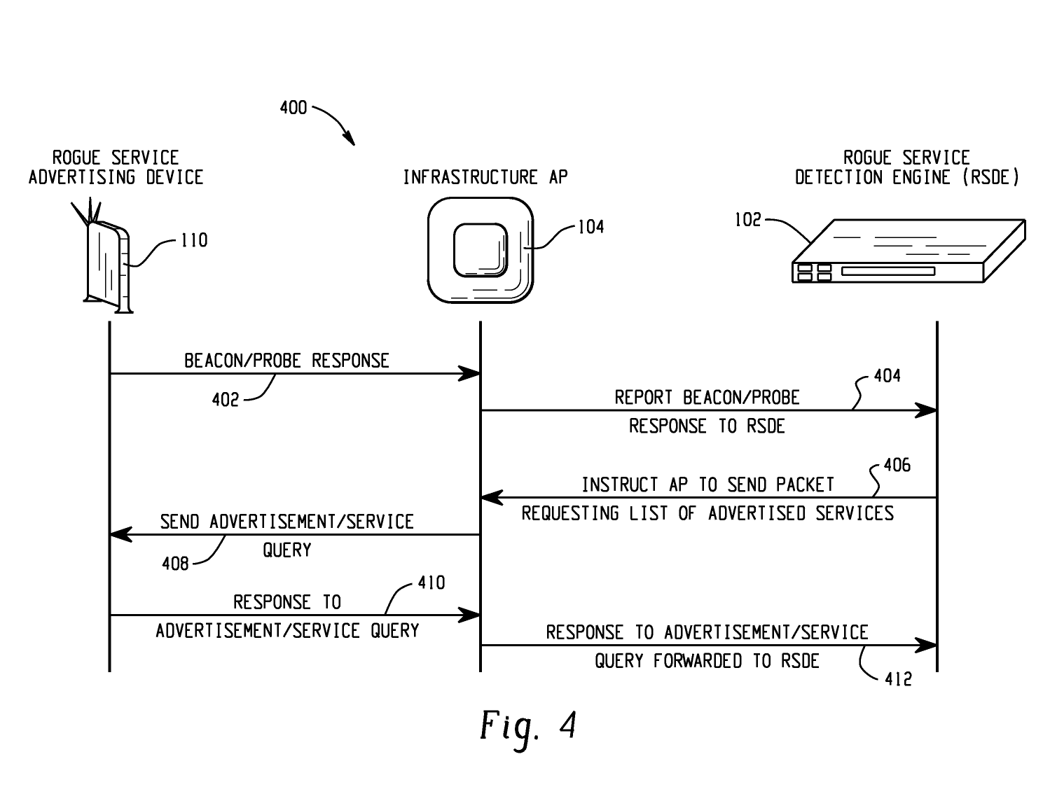

FIG. 4 is a signal diagram 400 for detecting a rogue service advertisement. In the illustrated example, signals sent by rogue service advertising device 110 are received by access point (AP) 104. AP 104 is in data communication with RSDE 102.

The AP 104 is monitoring beacons and/or probe responses for data indicating a device, such as rogue service advertising device 110, supports a predefined service advertisement protocol, such as MSAP and/or GAS. At 402, the AP 104 receives a signal (such as a beacon or probe response) from rogue service advertising device 110. The signal comprises data, such as an information element (IE), indicating that the rogue service advertising device 110 supports a service advertising protocol such as MSAP and/or GAS.

The AP 104 is operable to report receiving signals indicating that a device supports a predefined service advertising protocol to RSDE 102. Upon receiving the signal from the rogue service advertising device 110, the AP 104 reports the signal to RSDE 102 as illustrated by 404.

The AP 104 determines whether one or more of the APs receiving the signal from rogue service advertising device 110, such as AP 104, should send a request to the rogue service advertising device 110. At 406, the AP 104 instructs the AP 104 to request additional data (e.g., send a packet requesting advertised services) to the rogue service advertising device 110. At 408, the AP 104 sends a query for advertised services to the rogue service advertising device 110 in response to the instruction from RSDE 102.

The AP 104 waits for a response to the query from rogue service advertising device 110. At 410, the AP 104 receives the response from rogue service advertising device 110. The AP 104 forwards the response from the rogue service advertising device to the RSDE 102.

The RSDE 102 is now able to determine whether the rogue service advertising device 110 is a rogue device. The RSDE 102 may employ any of the techniques described herein for determining whether the rogue service advertising device 110 is a rogue device. Upon determining that the rouge service advertising device 110 is a rogue device, the RSDE 102 may generate an alarm.

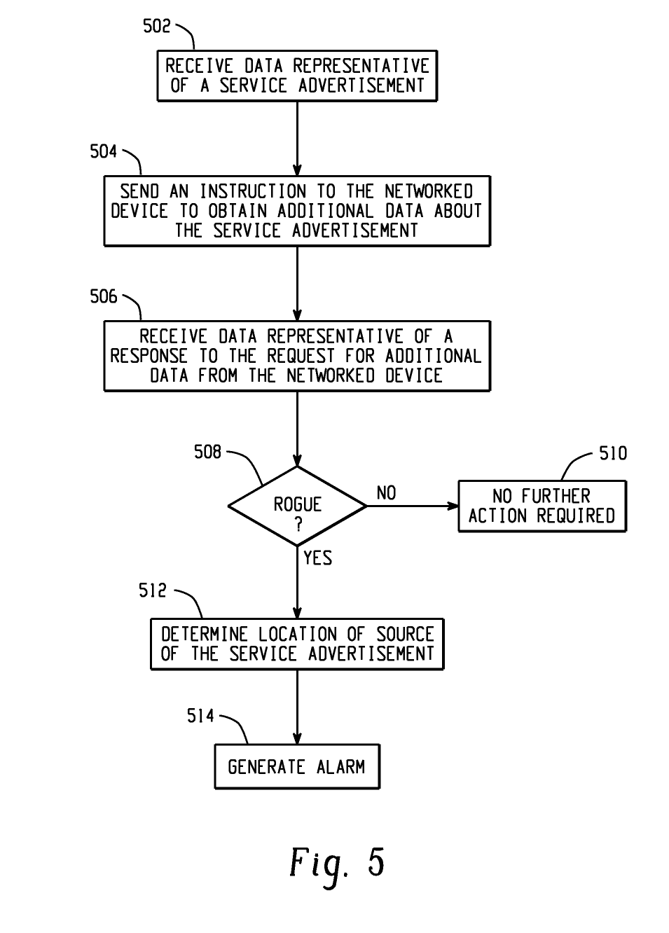

In view of the foregoing structural and functional features described above, a methodology 500 in accordance with an example embodiment will be better appreciated with reference to FIG. 5. While, for purposes of simplicity of explanation, the methodology 500 of FIG. 5 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an example embodiment. The methodology 500 described herein, is suitably adapted to be implemented in hardware, software, or a combination thereof. For example, methodology 500 may be implemented by the rogue service detection engine 102 in FIG. 1, the apparatus 200 in FIG. 2, and/or computer system 300 in FIG. 3.

At 502, a signal comprising data representative of a device sending an advertisement for a service advertisement protocol is received. The signal may be received directly from the device sending advertisement or may be sent by another device that received the advertisement, such as an access point that receives a wireless signal that comprises an advertisement from a wireless device.

At 504, a request for additional data from the device sending the advertisement for the service advertisement protocol is sent. The request may be sent directly to the device sending the advertisement or to another device that is in communication with the device sending the advertisement. The request may ask for a list of provided services, or service advertisements.

At 506, a response to the request is received. The response may suitably comprise data representative of one or more service advertisements, data representative of a domain name, data representative of a URI, textual and/or graphical data.

At 508, a determination is made whether the service advertisement (or the source of the service advertisement) is a rogue. In an example embodiment, the determination may be made based on the response received at 508. For example, if the response includes specific keywords, domain names, URI's, or the URI doesn't match the alleged service provider's URI, MAC address, and/or location of the sender doesn't match the expected location for the sender, the source of the service advertisement is determined to be a rogue.

If, at 508, the determination was made that the source of the service advertisement is not a rogue (NO), then no further action needs to be taken. However, in particular embodiments, other actions may be taken. For example, the event may be logged.

If, at 508, the determination was made that the source of the advertisement, or the advertisement, is a rogue (YES), then further action is taken. For example, at 512 the location of the source may be determined. The location of the device may be determined based on any suitable technique, such as RSSI, AOA, and/or obtained from a MSE. In an example embodiment, the location may be calculated based on the packet received at 506. At 514, an alarm is sent. The alarm may be sent to any predefined destination, such as an output device, or an email and/or SMS address. In particular embodiments, the alarm comprises data representative of the location of the device sending the advertisement. The alarm may also suitably comprise other data which may be of interest to a network administrator, such as who signed the response, why the alarm was generated, etc.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
an interface;
a rogue service detection engine coupled with the interface;
the rogue service detection engine is operable to receive a signal from a device on a network via the interface, the signal comprising data representative of a device sending an advertisement for a predefined service advertisement protocol;
the rogue service detection engine is operable to send, via the interface, an instruction to the device on the network to request additional data from the device sending the advertisement;
the rogue service detection engine is operable to receive, via the interface, data representative of a response to the request for additional data from the device on the network; and
the rogue service detection engine is operable to determine from the response whether the device sending the advertisement for the predefined service advertisement protocol is a rogue service advertisement.

2. The apparatus set forth in claim 1, the rogue service detection engine determines the location of the device sending the rogue service advertisement for the predefined service advertisement protocol responsive to determining that the device sending the advertisement for the predefined service advertisement protocol is a rogue device; and
wherein the rogue service detection engine is further operable to transmit an alarm indicating a rogue service advertisement has been detected, the alarm comprising the location of the device sending the rogue service advertisement for the predefined service advertisement protocol.

3. The apparatus set forth in claim 1, wherein the data representative of a response to the request for additional data comprises textual data;
the rogue service detection engine is operable to search the textual data for predefined keywords; and
the rogue service detection engine is operable to determine the device sending the advertisement for the predefined service advertisement protocol is a rogue device responsive to finding a one of the predefined keywords in the textual data.

4. The apparatus set forth in claim 1, wherein the data representative of a response comprises graphical data;
the rogue service detection engine is operable to perform an optical character recognition scan of the graphical data to obtain textual data;
the rogue service detection engine is operable to search the textual data for predefined keywords; and
the rogue service detection engine is operable to determine the device sending the advertisement for the predefined service advertisement protocol is a rogue device responsive to finding a one of the predefined keywords in the textual data.

5. The apparatus set forth in claim 1, wherein the response comprises a uniform resource locator (URL) and a source of the predefined service advertisement; and
the rogue service detection engine is operable to determine the device sending the advertisement for the predefined service advertisement protocol is a rogue device responsive to determining the URL does not match the source of the predefined service advertisement.

6. The apparatus set forth in claim 1, wherein the response comprises a uniform resource locator (URL);
the rogue service detection engine is operable to search a list of undesirable sites for the URL; and
the rogue service detection engine is operable to determine the device sending the advertisement for the predefined service advertisement protocol is a rogue device responsive to finding a match for the URL in the list of undesirable sites.

7. The apparatus set forth in claim 6, wherein the list of undesirable sites includes data representative of competitor sites.

8. The apparatus set forth in claim 1, the response comprises a domain name;
the rogue service detection engine is operable to search for the domain name in a list of unsafe sites; and
the rogue service detection engine is operable to determine the device sending the advertisement for the predefined service advertisement protocol is a rogue device responsive to finding a match for the domain name in the list of unsafe sites.

9. The apparatus set forth in claim 1, the rogue service detection engine is operable to search a database comprising approved service advertisements for the service advertisement.

10. The apparatus set forth in claim 9, the rogue service detection engine is operable to search a database of unapproved service advertisements for the service advertisement responsive to not finding the service advertisement in the database comprising approved service advertisements.

11. The apparatus set forth in claim 10, the rogue service detection engine is operable to send a message to a predefined destination responsive to not finding the service advertisement in the database of unapproved service advertisements and not finding the service advertisement in the database of approved service advertisements.

12. The apparatus set forth in claim 1, the rogue service detection engine is operable to obtain a media access control (MAC) address associated with the device sending the advertisement for the predefined service advertisement protocol;
the rogue service detection engine is operable to search a database of approved MAC addresses for the MAC address associated with the device sending the advertisement for the predefined service advertisement protocol; and
the rogue service detection engine determines that the device sending the advertisement for the predefined service advertisement protocol is a rogue device responsive to not finding the MAC address associated with the device sending the advertisement for the predefined service advertisement protocol in the database of approved MAC addresses.

13. The apparatus set forth in claim 1, the rogue service detection engine is operable to determine a location of the device sending the advertisement for the predefined service advertisement protocol;
the rogue service detection engine is further operable to determine a media access control (MAC) address associated with the device sending the advertisement for the predefined service advertisement protocol;
the rogue service detection engine is operable to search a database of approved MAC addresses for the MAC address associated with the device sending the advertisement for the predefined service advertisement protocol;
the rogue service detection engine determines whether the location of the device sending the advertisement for the predefined service advertisement protocol matches a location for the MAC address in the database of approved MAC addresses; and
the rogue service detection engine is operable to generate an alarm responsive to determining the location of the device sending the advertisement for the predefined service advertisement protocol does not match the location for the MAC address in the database of approved MAC addresses.

14. The apparatus set forth in claim 1, wherein the response is signed; and
the rogue service detection engine is operable to determine who signed the response.

15. The apparatus set forth in claim 1, wherein the predefined service advertisement protocol is selected from a group consisting of a mobility service advertisement protocol and a generic advertising service protocol.

16. Logic encoded in a non-transitory tangible computer readable medium for execution by a processor, and when executed operable to:
receive a signal comprising data representative of a device sending an advertisement for a predefined service advertisement protocol;
send a request for additional data from the device sending the advertisement for the predefined service advertisement protocol;
receive data representative of a response to the request for additional data; and
determine whether the device sending the advertisement for the predefined service advertisement protocol is a rogue device.

17. The logic set forth in claim 16, further operable to:
obtain textual data from the response;
search the textual data for predefined keywords; and
determine that the device sending the advertisement for the predefined service advertisement protocol is a rogue device responsive to finding a one of the predefined keywords in the textual data.

18. The logic set forth in claim 16, wherein the response comprises a uniform resource locator (URL);
the rogue service detection engine is operable to search for the URL in a list of undesirable sites; and
determine the device sending the advertisement for the predefined service advertisement protocol is a rogue device responsive to finding a match for the URL in the list of undesirable sites.

19. The logic set forth in claim 16, wherein the response comprises a uniform resource locator (URL) and a source of the service advertisement; and
determine the device sending the advertisement for the predefined service advertisement protocol is a rogue device responsive to determining the URL does not match the source of the service advertisement.

20. A method, comprising:
receiving a signal comprising data representative of a device sending an advertisement for a predefined service advertisement protocol;
sending a request, by a processor, for additional data from the device sending the advertisement for the predefined service advertisement protocol;
receiving data representative of a response to the request for additional data; and
determining, by the processor, whether the device sending the advertisement for the predefined service advertisement protocol is a rogue device;
determining a location of the device sending the advertisement; and
the processor sending an alarm responsive to determining the device sending the advertisement is a rogue device;
wherein the alarm comprises data representative of the location of the device sending the advertisement.
